(19) United States
(12) Patent Application Publication
(10) Pub. No.: US 2015/0070489 A1
(43) Pub. Date: Mar. 12, 2015

(54) OPTICAL MODULES FOR USE WITH DEPTH CAMERAS

(71) Applicant: Microsoft Corporation, Redmond, WA (US)

(72) Inventors: Joshua Hudman, Issaquah, WA (US); Prafulla Masalkar, Issaquah, WA (US)

(73) Assignee: Microsoft Corporation, Redmond, WA (US)

(21) Appl. No.: 14/023,990

(22) Filed: Sep. 11, 2013

(51) Int. Cl. G02B 7/02; G06T 7/00

(52) U.S. Cl. CPC G02B 7/021; G06T 7/0057
USPC 348/135

(57) ABSTRACT

Disclosed herein are optical modules for use with depth cameras, and systems that include a depth camera. The optical module spreads out a laser beam, output by a laser source of the optical module, so that the laser beam output by the optical module does not look bright, and thus, does not draw attention to the laser light. Such an optical module can include an optical structure that modifies the laser beam so that its horizontal and vertical angles of divergence are substantially equal to desired horizontal and vertical angles of divergence, and so that its illumination profile is substantially equal to a desired illumination profile. This is beneficial since a scene should be illuminated by light having predetermined desired horizontal and vertical angles of divergence and a predetermined desired illumination profile in order for a depth camera to obtain high resolution depth images.

### BACKGROUND

A depth camera can obtain depth images including information about a location of a human or other object in a physical space. The depth images may be used by an application in a computing system for a wide variety of applications. Many applications are possible, such as for military, entertainment, sports and medical purposes. For instance, depth images including information about a human can be mapped to a three-dimensional (3-D) human skeletal model and used to create an animated character or avatar.

To obtain a depth image, a depth camera typically project lights onto an object in the camera's field of view. The light reflects off the object and back to the camera, where it is incident on an image pixel detector array of the camera, and is processed to determine the depth image.

The light projected by a depth camera can be a high frequency modulated laser beam generated using a laser source that outputs an infrared (IR) laser beam. While an IR laser beam traveling through the air is not visible to the human eye, the point from which the IR laser beam is output from the depth camera may look very bright and draw attention to the laser light. This can be distracting, and thus, is undesirable.

### SUMMARY

Certain embodiments of the present technology are related to optical modules for use with depth cameras, and systems that include a depth camera, which can be referred to as depth camera systems. Such optical modules are used to spread out a laser beam, output by a laser source of the optical module, so that the laser beam output by the optical module does not look bright, and thus, does not draw attention to the laser light. More specifically, such optical modules include an optical structure that modifies the laser beam so that its horizontal and vertical angles of divergence are substantially equal to desired horizontal and vertical angles of divergence, and so that its illumination profile is substantially equal to a desired illumination profile. This is beneficial since a scene should be illuminated by light having predetermined desired horizontal and vertical angles of divergence and a predetermined desired illumination profile in order for a depth camera to obtain high resolution depth images.

In accordance with an embodiment, a depth camera system includes a laser source, an optical structure and an image pixel detector array. The laser source outputs a laser beam. The optical structure receives the laser beam output by the laser source and spreads out the laser beam output by the laser source in at least two stages so that the laser beam output from the optical structure has horizontal and vertical angles of divergence substantially equal to desired horizontal and vertical angles of divergence. The optical structure also achieves an illumination profile substantially equal to a desired illumination profile. The image pixel detector array detects a portion of the laser beam, output by the optical structure, that has reflected of an object within the field of view of the depth camera and is incident on the image pixel detector array. Such a depth camera system can also include one or more processors that produce depth images in dependence on outputs of the image pixel detector array, and update an application based on the depth images.

In a specific embodiment, the optical structure of the optical module includes a meniscus lens followed by a micro lens array. The meniscus lens performs some initial spreading of the beam, and then the micro lens array performs further spreading of the beam and is also used to achieve the illumination profile that is substantially equal to the desired illumination profile. The meniscus lens includes a concave lens surface followed by a convex lens surface, each of which adjusts horizontal and vertical angles of divergence of the laser beam. Accordingly, the meniscus lens can be said to perform a first stage of beam spreading, and the optically downstream micro-lens array can be said to perform a second stage of the beam spreading.

In alternative embodiments, the first stage beam spreading can be performed by a micro-lens array, a diffractive optical element or a gradient-index lens, instead of a meniscus lens. Where the first and second beam spreading is performed by first and second micro-lens arrays, then the optical structure can be a double sided micro-lens array. In other embodiments, the second stage beam spreading is performed by a diffractive optical element or an optical diffuser, instead of a micro-lens array.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a tracking system with a user playing a game.

FIG. 2A illustrates an example embodiment of a capture device that may be used as part of the tracking system.

FIG. 2B illustrates an exemplary embodiment of a depth camera that may be part of the capture device of FIG. 2A.

FIG. 3 illustrates an example embodiment of a computing system that may be used to track user behavior and update an application based on the user behavior.

FIG. 4 illustrates another example embodiment of a computing system that may be used to track user behavior and update an application based on the tracked user behavior.

FIG. 5 illustrates an exemplary depth image.

FIG. 6 depicts exemplary data in an exemplary depth image.

FIG. 7 illustrates an optical module for use with a depth camera, according to an embodiment of the present technology.

FIG. 8 illustrates an optical module for use with a depth camera, according to another embodiment of the present technology.

FIG. 9 is a high level flow diagram that is used to summarize methods according to various embodiments of the present technology.

FIG. 10 illustrates how optical structures of embodiments of the present technology can be used to significantly increase the footprint of a laser beam over a relatively short path length.

FIG. 11 illustrates an exemplary desired illumination profile.

### DETAILED DESCRIPTION

Certain embodiments of the present technology disclosed herein are related to optical modules for use with depth cameras, and systems that include a depth camera, which can be referred to as depth camera systems. Before providing additional details of such embodiments of the present technology, exemplary details of larger systems with which embodiments of the present technology can be used will first be described.

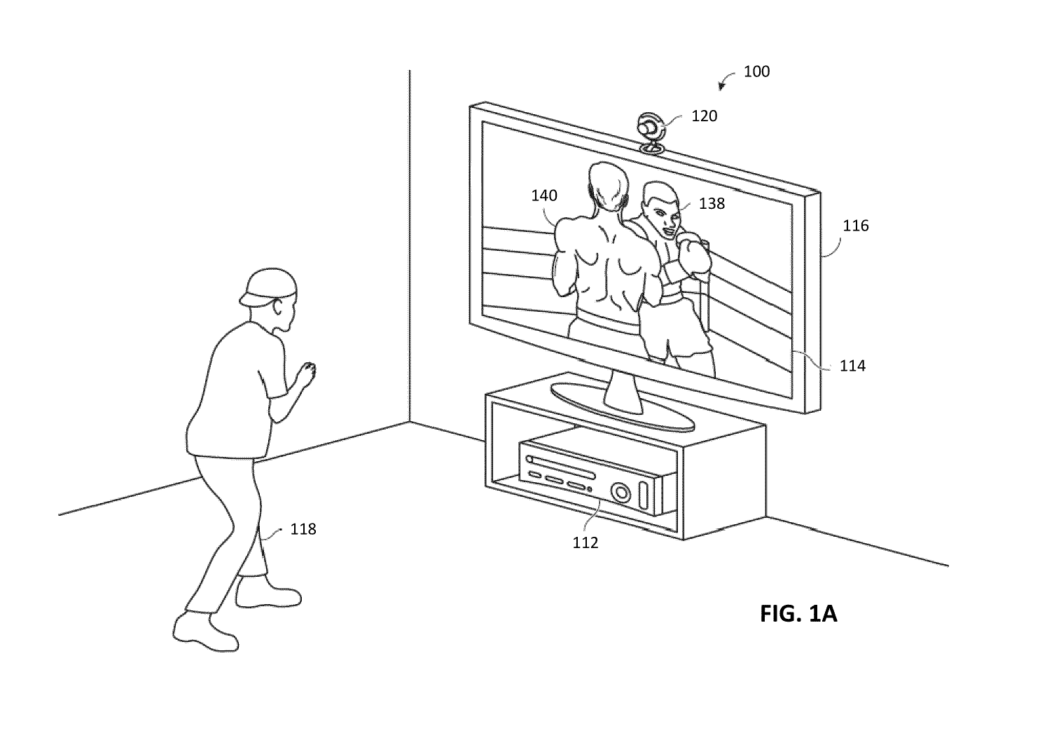

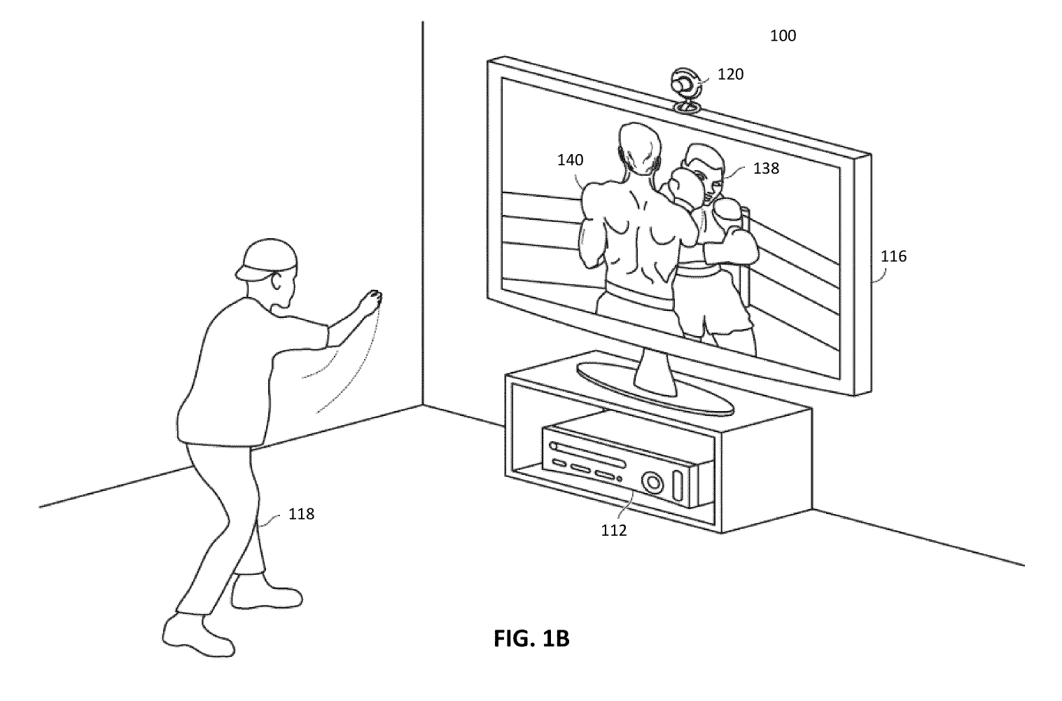

FIGS. 1A and 1B illustrate an example embodiment of a tracking system 100 with a user 118 playing a boxing video game. In an example embodiment, the tracking system 100 may be used to recognize, analyze, and/or track a human target such as the user 118 or other objects within range of the tracking system 100. As shown in FIG. 1A, the tracking system 100 includes a computing system 112 and a capture device 120. As will be describe in additional detail below, the capture device 120 can be used to obtain depth images and color images (also known as RGB images) that can be used by the computing system 112 to identify one or more users or other objects, as well as to track motion and/or other user behaviors. The tracked motion and/or other user behavior can be used to update an application. Therefore, a user can manipulate game characters or other aspects of the application by using movement of the user's body and/or objects around the user, rather than (or in addition to) using controllers, remotes, keyboards, mice, or the like. For example, a video game system can update the position of images displayed in a video game based on the new positions of the objects or update an avatar based on motion of the user.

The computing system 112 may be a computer, a gaming system or console, or the like. According to an example embodiment, the computing system 112 may include hardware components and/or software components such that computing system 112 may be used to execute applications such as gaming applications, non-gaming applications, or the like. In one embodiment, computing system 112 may include a processor such as a standardized processor, a specialized processor, a microprocessor, or the like that may execute instructions stored on a processor readable storage device for performing the processes described herein.

The capture device 120 may include, for example, a camera that may be used to visually monitor one or more users, such as the user 118, such that gestures and/or movements performed by the one or more users may be captured, analyzed, and tracked to perform one or more controls or actions within the application and/or animate an avatar or on-screen character, as will be described in more detail below.

According to one embodiment, the tracking system 100 may be connected to an audiovisual device 116 such as a television, a monitor, a high-definition television (HDTV), or the like that may provide game or application visuals and/or audio to a user such as the user 118. For example, the computing system 112 may include a video adapter such as a graphics card and/or an audio adapter such as a sound card that may provide audiovisual signals associated with the game application, non-game application, or the like. The audiovisual device 116 may receive the audiovisual signals from the computing system 112 and may then output the game or application visuals and/or audio associated with the audiovisual signals to the user 118. According to one embodiment, the audiovisual device 16 may be connected to the computing system 112 via, for example, an S-Video cable, a coaxial cable, an HDMI cable, a DVI cable, a VGA cable, component video cable, or the like.

As shown in FIGS. 1A and 1B, the tracking system 100 may be used to recognize, analyze, and/or track a human target such as the user 118. For example, the user 118 may be tracked using the capture device 120 such that the gestures and/or movements of user 118 may be captured to animate an avatar or on-screen character and/or may be interpreted as controls that may be used to affect the application being executed by computing system 112. Thus, according to one embodiment, the user 118 may move his or her body to control the application and/or animate the avatar or on-screen character.

In the example depicted in FIGS. 1A and 1B, the application executing on the computing system 112 may be a boxing game that the user 118 is playing. For example, the computing system 112 may use the audiovisual device 116 to provide a visual representation of a boxing opponent 138 to the user 118. The computing system 112 may also use the audiovisual device 116 to provide a visual representation of a player avatar 140 that the user 118 may control with his or her movements. For example, as shown in FIG. 1B, the user 118 may throw a punch in physical space to cause the player avatar 140 to throw a punch in game space. Thus, according to an example embodiment, the computer system 112 and the capture device 120 recognize and analyze the punch of the user 118 in physical space such that the punch may be interpreted as a game control of the player avatar 140 in game space and/or the motion of the punch may be used to animate the player avatar 140 in game space.

Other movements by the user 118 may also be interpreted as other controls or actions and/or used to animate the player avatar, such as controls to bob, weave, shuffle, block, jab, or throw a variety of different power punches. Furthermore, some movements may be interpreted as controls that may correspond to actions other than controlling the player avatar 140. For example, in one embodiment, the player may use movements to end, pause, or save a game, select a level, view high scores, communicate with a friend, etc. According to another embodiment, the player may use movements to select the game or other application from a main user interface. Thus, in example embodiments, a full range of motion of the user 118 may be available, used, and analyzed in any suitable manner to interact with an application.

In example embodiments, the human target such as the user 118 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game. Objects not held by the user can also be tracked, such as objects thrown, pushed or rolled by the user (or a different user) as well as self-propelled objects. In addition to boxing, other games can also be implemented.

According to other example embodiments, the tracking system 100 may further be used to interpret target movements as operating system and/or application controls that are outside the realm of games. For example, virtually any controllable aspect of an operating system and/or application may be controlled by movements of the target such as the user 118.

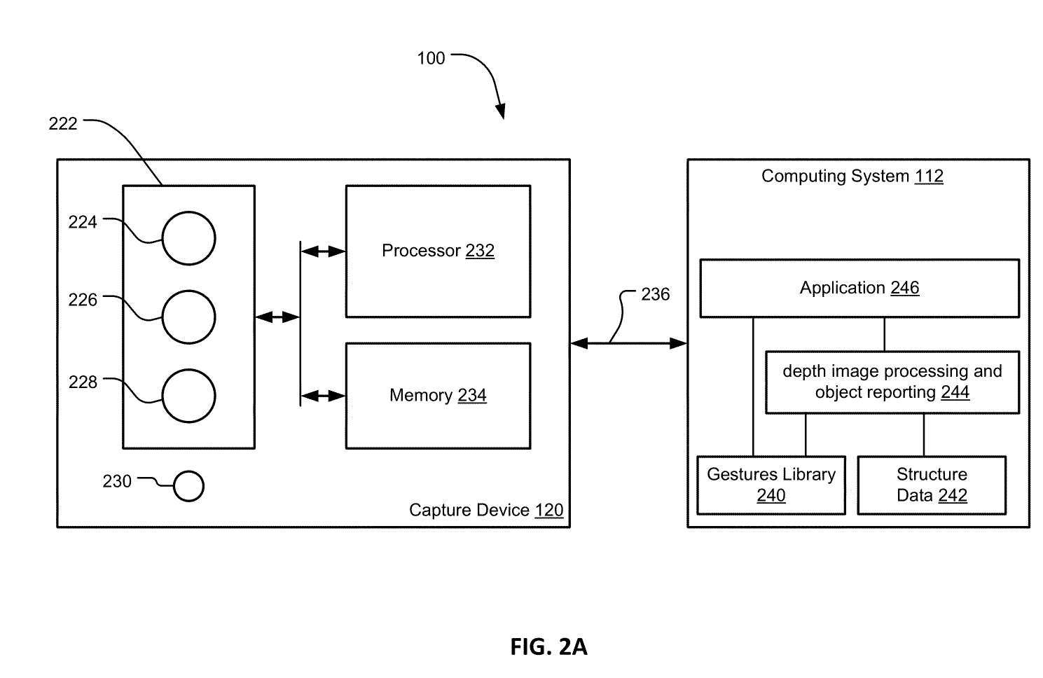

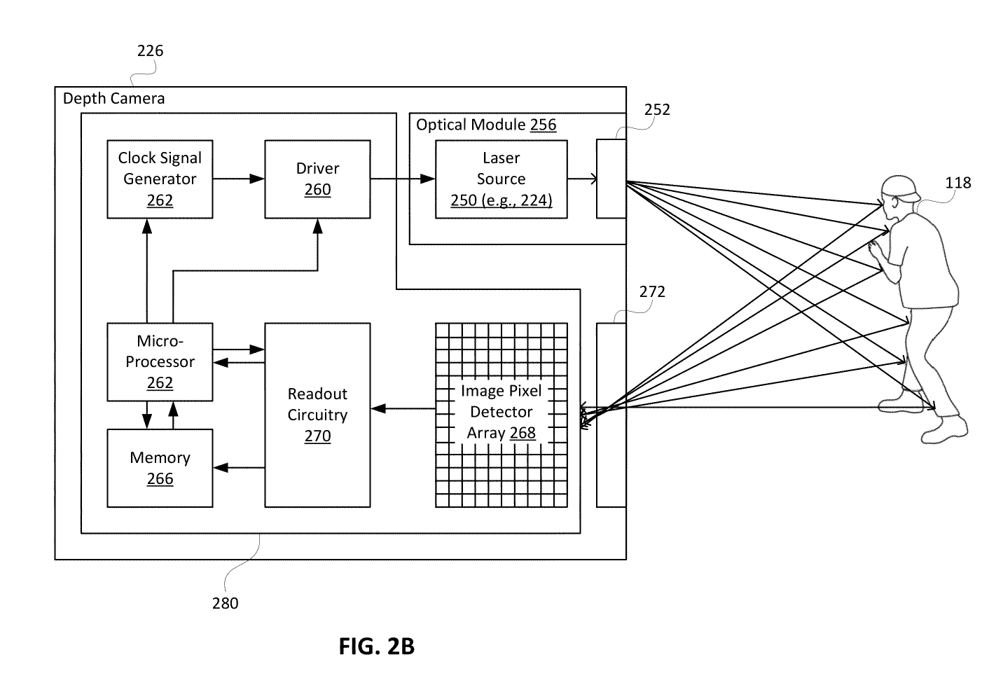

FIG. 2A illustrates an example embodiment of the capture device 120 that may be used in the tracking system 100. According to an example embodiment, the capture device 120 may be configured to capture video with depth information including a depth image that may include depth values via any suitable technique including, for example, time-of-flight, structured light, stereo image, or the like. According to one embodiment, the capture device 120 may organize the depth information into “Z layers,” or layers that may be perpendicular to a Z axis extending from the depth camera along its line of sight.

As shown in FIG. 2A, the capture device 120 may include an image camera component 222. According to an example embodiment, the image camera component 222 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2A, according to an example embodiment, the image camera component 222 may include an infra-red (IR) light component 224, a three-dimensional (3-D) camera 226, and an RGB camera 228 that may be used to capture the depth image of a scene. For example, in time-of-flight (TOF) analysis, the IR light component 224 of the capture device 120 may emit an infrared light onto the scene and may then use sensors (not specifically shown in FIG. 2A) to detect the backscattered light from the surface of one or more targets and objects in the scene using, for example, the 3-D camera 226 and/or the RGB camera 228. In some embodiments, pulsed IR light may be used such that the time between an outgoing light pulse and a corresponding incoming light pulse may be measured and used to determine a physical distance from the capture device 120 to a particular location on the targets or objects in the scene. Additionally or alternatively, the phase of the outgoing light wave may be compared to the phase of the incoming light wave to determine a phase shift. The phase shift may then be used to determine a physical distance from the capture device to a particular location on the targets or objects. Additional details of an exemplary TOF type of 3-D camera 226, which can also be referred to as a depth camera, are described below with reference to FIG. 2B.

According to another example embodiment, TOF analysis may be used to indirectly determine a physical distance from the capture device 120 to a particular location on the targets or objects by analyzing the intensity of the reflected beam of light over time via various techniques including, for example, shuttered light pulse imaging.

In another example embodiment, the capture device 120 may use a structured light to capture depth information. In such an analysis, patterned light (i.e., light displayed as a known pattern such as grid pattern, a stripe pattern, or different pattern) may be projected onto the scene via, for example, the IR light component 224. Upon striking the surface of one or more targets or objects in the scene, the pattern may become deformed in response. Such a deformation of the pattern may be captured by, for example, the 3-D camera 226 and/or the RGB camera 228 and may then be analyzed to determine a physical distance from the capture device to a particular location on the targets or objects. In some implementations, the IR Light component 224 is displaced from the cameras 226 and 228 so triangulation can be used to determined distance from cameras 226 and 228. In some implementations, the capture device 120 will include a dedicated IR sensor to sense the IR light.

According to another embodiment, the capture device 120 may include two or more physically separated cameras that may view a scene from different angles to obtain visual stereo data that may be resolved to generate depth information. Other types of depth image sensors can also be used to create a depth image.

The capture device 120 may further include a microphone 230. The microphone 230 may include a transducer or sensor that may receive and convert sound into an electrical signal. According to one embodiment, the microphone 230 may be used to reduce feedback between the capture device 120 and the computing system 112 in the target recognition, analysis, and tracking system 100. Additionally, the microphone 230 may be used to receive audio signals (e.g., voice commands) that may also be provided by the user to control applications such as game applications, non-game applications, or the like that may be executed by the computing system 112.

In an example embodiment, the capture device 120 may further include a processor 232 that may be in operative communication with the image camera component 222. The processor 232 may include a standardized processor, a specialized processor, a microprocessor, or the like that may execute instructions including, for example, instructions for receiving a depth image, generating the appropriate data format (e.g., frame) and transmitting the data to computing system 112.

The capture device 120 may further include a memory component 234 that may store the instructions that may be executed by the processor 232, images or frames of images captured by the 3-D camera and/or RGB camera, or any other suitable information, images, or the like. According to an example embodiment, the memory component 234 may include random access memory (RAM), read only memory (ROM), cache, Flash memory, a hard disk, or any other suitable storage component. As shown in FIG. 2A, in one embodiment, the memory component 234 may be a separate component in communication with the image capture component 222 and the processor 232. According to another embodiment, the memory component 234 may be integrated into the processor 232 and/or the image capture component 222.

As shown in FIG. 2A, the capture device 120 may be in communication with the computing system 212 via a communication link 236. The communication link 236 may be a wired connection including, for example, a USB connection, a Firewire connection, an Ethernet cable connection, or the like and/or a wireless connection such as a wireless 802.11b, g, a, or n connection. According to one embodiment, the computing system 112 may provide a clock to the capture device 120 that may be used to determine when to capture, for example, a scene via the communication link 236. Additionally, the capture device 120 provides the depth images and color images captured by, for example, the 3-D camera 226 and/or the RGB camera 228 to the computing system 112 via the communication link 236. In one embodiment, the depth images and color images are transmitted at 30 frames per second. The computing system 112 may then use the model, depth information, and captured images to, for example, control an application such as a game or word processor and/or animate an avatar or on-screen character.

Computing system 112 includes gestures library 240, structure data 242, depth image processing and object reporting module 244 and application 246. Depth image processing and object reporting module 244 uses the depth images to track motion of objects, such as the user and other objects. To assist in the tracking of the objects, depth image processing and object reporting module 244 uses gestures library 240 and structure data 242.

Structure data 242 includes structural information about objects that may be tracked. For example, a skeletal model of a human may be stored to help understand movements of the user and recognize body parts. Structural information about inanimate objects may also be stored to help recognize those objects and help understand movement.

Gestures library 240 may include a collection of gesture filters, each comprising information concerning a gesture that may be performed by the skeletal model (as the user moves). The data captured by the cameras 226, 228 and the capture device 120 in the form of the skeletal model and movements associated with it may be compared to the gesture filters in the gesture library 240 to identify when a user (as represented by the skeletal model) has performed one or more gestures. Those gestures may be associated with various controls of an application. Thus, the computing system 112 may use the gestures library 240 to interpret movements of the skeletal model and to control application 246 based on the movements. As such, gestures library may be used by depth image processing and object reporting module 244 and application 246.

Application 246 can be a video game, productivity application, etc. In one embodiment, depth image processing and object reporting module 244 will report to application 246 an identification of each object detected and the location of the object for each frame. Application 246 will use that information to update the position or movement of an avatar or other images in the display.

FIG. 2B illustrates an example embodiment of a 3-D camera 226, which can also be referred to as a depth camera 226. The depth camera 226 is shown as including a driver 260 that drives a laser source 250 of an optical module 256. The laser source 250 can be, e.g., the IR light component 224 shown in FIG. 2A. More specifically, the laser source 250 can include one or more laser emitting elements, such as, but not limited to, edge emitting laser diodes or vertical-cavity surface-emitting lasers (VCSELs). While it is likely that such laser emitting elements emit IR light, light of alternative wavelengths can alternatively be emitted by the laser emitting elements.

The depth camera 226 is also shown as including a clock signal generator 262, which produces a clock signal that is provided to the driver 260. Additionally, the depth camera 226 is shown as including a microprocessor 264 that can control the clock signal generator 262 and/or the driver 260. The depth camera 226 is also shown as including an image pixel detector array 268, readout circuitry 270 and memory 266. The image pixel detector array 268 might include, e.g., 320×240 image pixel detectors, but is not limited thereto. Each image pixel detector can be, e.g., a complementary metal-oxide-semiconductor (CMOS) sensor or a charged coupled device (CCD) sensor, but is not limited thereto. Depending upon implementation, each image pixel detector can have its own dedicated readout circuit, or readout circuitry can be shared by many image pixel detectors. In accordance with certain embodiments, the components of the depth camera 226 shown within the block 280 are implemented in a single integrated circuit (IC), which can also be referred to as a single chip.

In accordance with an embodiment, the driver 260 produces a high frequency (HF) modulated drive signal in dependence on a clock signal received from clock signal generator 262. Accordingly, the driver 260 can include, for example, one or more buffers, amplifiers and/or modulators, but is not limited thereto. The clock signal generator 262 can include, for example, one or more reference clocks and/or voltage controlled oscillators, but is not limited thereto. The microprocessor 264, which can be part of a microcontroller unit, can be used to control the clock signal generator 262 and/or the driver 260. For example, the microprocessor 264 can access waveform information stored in the memory 266 in order to produce an HF modulated drive signal. The depth camera 226 can includes its own memory 266 and microprocessor 264, as shown in FIG. 2B. Alternatively, or additionally, the processor 232 and/or memory 234 of the capture device 120 can be used to control aspects of the depth camera 226.

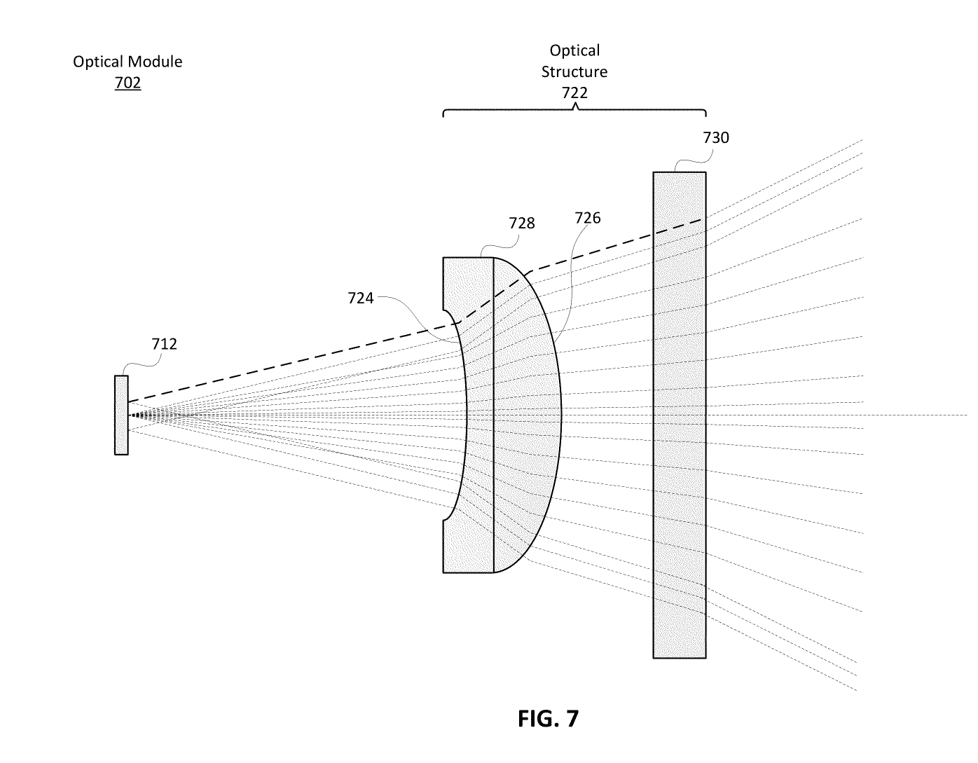

In response to being driven by an HF modulated drive signal, the laser source 250 emits an HF modulated laser beam, which can more generally be referred to as a laser beam. For an example, a carrier frequency of the HF modulated drive signal and the HF modulated laser beam can be in a range from about 30 MHz to many hundreds of MHz, but for illustrative purposes will be assumed to be about 100 MHz. The laser beam emitted by the laser source 250 is transmitted through an optical structure 252, which can include one or more lens and/or other optical element(s), towards a target object (e.g., a user 118). The laser source 250 and the optical structure 252 can be referred to, collectively, as an optical module 256. In accordance with certain embodiments of the present technology, discussed below with reference to FIGS. 7-9, the optical structure 252 receives the laser beam output by the laser source 250, spreads out the laser beam in at least two stages so that the laser beam output from the optical structure 252 has horizontal and vertical angles of divergence substantially equal to desired horizontal and vertical angles of divergence, and modifies an illumination profile of the laser beam so that the illumination profile of the laser beam output from the optical structure 252 is substantially equal to a desired illumination profile.

Assuming that there is a target object within the field of view of the depth camera, a portion of the laser beam reflects off the target object, passes through an aperture field stop and lens (collectively 272), and is incident on the image pixel detector array 268 where an image is formed. In some implementations, each individual image pixel detector of the array 268 produces an integration value indicative of a magnitude and a phase of detected HF modulated laser beam originating from the optical module 256 that has reflected off the object and is incident of the image pixel detector. Such integrations values, or more generally time-of-flight (TOF) information, enable distances (Z) to be determined, and collectively, enable depth images to be produced. In certain embodiments, optical energy from the light source 250 and detected optical energy signals are synchronized to each other such that a phase difference, and thus a distance Z, can be measured from each image pixel detector. The readout circuitry 270 converts analog integration values generated by the image pixel detector array 268 into digital readout signals, which are provided to the microprocessor 264 and/or the memory 266, and which can be used to produce depth images.

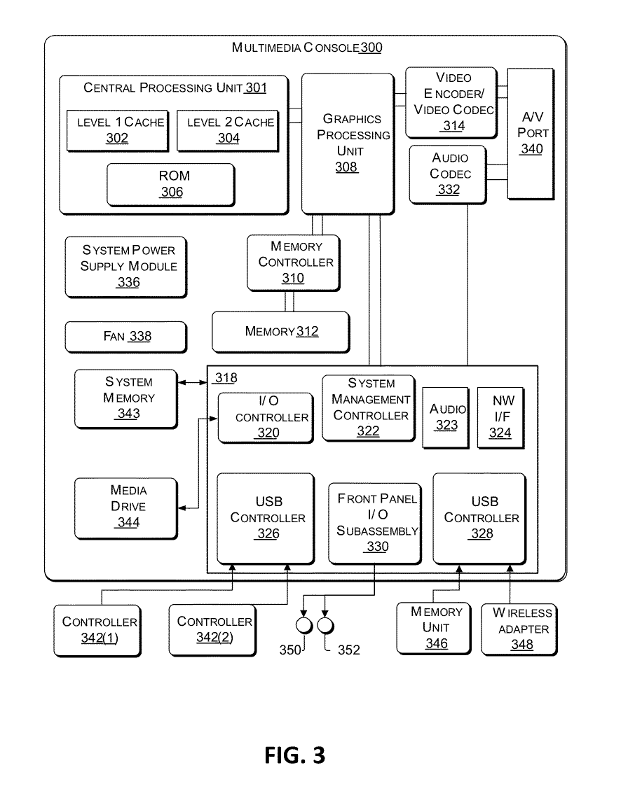

FIG. 3 illustrates an example embodiment of a computing system that may be the computing system 112 shown in FIGS. 1A-2B used to track motion and/or animate (or otherwise update) an avatar or other on-screen object displayed by an application. The computing system such as the computing system 112 described above with respect to FIGS. 1A-2 may be a multimedia console, such as a gaming console. As shown in FIG. 3, the multimedia console 300 has a central processing unit (CPU) 301 having a level 1 cache 102, a level 2 cache 304, and a flash ROM (Read Only Memory) 306. The level 1 cache 302 and a level 2 cache 304 temporarily store data and hence reduce the number of memory access cycles, thereby improving processing speed and throughput. The CPU 301 may be provided having more than one core, and thus, additional level 1 and level 2 caches 302 and 304. The flash ROM 306 may store executable code that is loaded during an initial phase of a boot process when the multimedia console 300 is powered ON.

A graphics processing unit (GPU) 308 and a video encoder/video codec (coder/decoder) 314 form a video processing pipeline for high speed and high resolution graphics processing. Data is carried from the graphics processing unit 308 to the video encoder/video codec 314 via a bus. The video processing pipeline outputs data to an A/V (audio/video) port 340 for transmission to a television or other display. A memory controller 310 is connected to the GPU 308 to facilitate processor access to various types of memory 312, such as, but not limited to, a RAM (Random Access Memory).

The multimedia console 300 includes an I/O controller 320, a system management controller 322, an audio processing unit 323, a network interface 324, a first USB host controller 326, a second USB controller 328 and a front panel I/O subassembly 330 that are preferably implemented on a module 318. The USB controllers 326 and 328 serve as hosts for peripheral controllers 342(1)-342(2), a wireless adapter 348, and an external memory device 346 (e.g., flash memory, external CD/DVD ROM drive, removable media, etc.). The network interface 324 and/or wireless adapter 348 provide access to a network (e.g., the Internet, home network, etc.) and may be any of a wide variety of various wired or wireless adapter components including an Ethernet card, a modem, a Bluetooth module, a cable modem, and the like.

System memory 343 is provided to store application data that is loaded during the boot process. A media drive 344 is provided and may comprise a DVD/CD drive, Blu-Ray drive, hard disk drive, or other removable media drive, etc. The media drive 344 may be internal or external to the multimedia console 300. Application data may be accessed via the media drive 344 for execution, playback, etc. by the multimedia console 300. The media drive 344 is connected to the I/O controller 320 via a bus, such as a Serial ATA bus or other high speed connection (e.g., IEEE 1394).

The system management controller 322 provides a variety of service functions related to assuring availability of the multimedia console 300. The audio processing unit 323 and an audio codec 332 form a corresponding audio processing pipeline with high fidelity and stereo processing. Audio data is carried between the audio processing unit 323 and the audio codec 332 via a communication link. The audio processing pipeline outputs data to the A/V port 340 for reproduction by an external audio player or device having audio capabilities.

The front panel I/O subassembly 330 supports the functionality of the power button 350 and the eject button 352, as well as any LEDs (light emitting diodes) or other indicators exposed on the outer surface of the multimedia console 300. A system power supply module 336 provides power to the components of the multimedia console 300. A fan 338 cools the circuitry within the multimedia console 300.

The CPU 301, GPU 308, memory controller 310, and various other components within the multimedia console 300 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 300 is powered ON, application data may be loaded from the system memory 343 into memory 312 and/or caches 302, 304 and executed on the CPU 301. The application may present a graphical user interface that provides a consistent user experience when navigating to different media types available on the multimedia console 300. In operation, applications and/or other media contained within the media drive 344 may be launched or played from the media drive 344 to provide additional functionalities to the multimedia console 300.

The multimedia console 300 may be operated as a standalone system by simply connecting the system to a television or other display. In this standalone mode, the multimedia console 300 allows one or more users to interact with the system, watch movies, or listen to music. However, with the integration of broadband connectivity made available through the network interface 324 or the wireless adapter 348, the multimedia console 300 may further be operated as a participant in a larger network community.

When the multimedia console 300 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 Kbps), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 300 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 301 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 342(1) and 342(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 226, 228 and capture device 120 may define additional input devices for the console 300 via USB controller 326 or other interface.

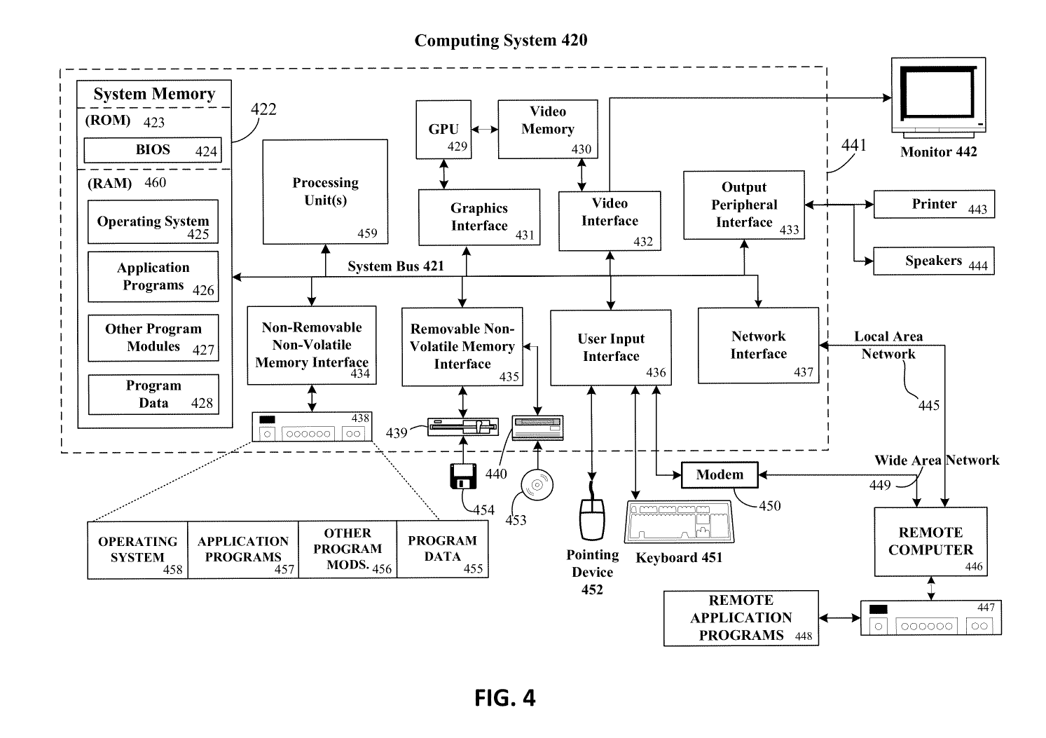

FIG. 4 illustrates another example embodiment of a computing system 420 that may be the computing system 112 shown in FIGS. 1A-2B used to track motion and/or animate (or otherwise update) an avatar or other on-screen object displayed by an application. The computing system 420 is only one example of a suitable computing system and is not intended to suggest any limitation as to the scope of use or functionality of the presently disclosed subject matter. Neither should the computing system 420 be interpreted as having any dependency or requirement relating to any one or combination of components illustrated in the exemplary computing system 420. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 420 comprises a computer 441, which typically includes a variety of computer readable media. Computer readable media can be any available media that can be accessed by computer 441 and includes both volatile and nonvolatile media, removable and non-removable media. The system memory 422 includes computer storage media in the form of volatile and/or nonvolatile memory such as read only memory (ROM) 423 and random access memory (RAM) 460. A basic input/output system 424 (BIOS), containing the basic routines that help to transfer information between elements within computer 441, such as during start-up, is typically stored in ROM 423. RAM 460 typically contains data and/or program modules that are immediately accessible to and/or presently being operated on by processing unit 459. By way of example, and not limitation, FIG. 4 illustrates operating system 425, application programs 426, other program modules 427, and program data 428.

The computer 441 may also include other removable/non-removable, volatile/nonvolatile computer storage media. By way of example only, FIG. 4 illustrates a hard disk drive 438 that reads from or writes to non-removable, nonvolatile magnetic media, a magnetic disk drive 439 that reads from or writes to a removable, nonvolatile magnetic disk 454, and an optical disk drive 440 that reads from or writes to a removable, nonvolatile optical disk 453 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 438 is typically connected to the system bus 421 through an non-removable memory interface such as interface 434, and magnetic disk drive 439 and optical disk drive 440 are typically connected to the system bus 421 by a removable memory interface, such as interface 435.

The drives and their associated computer storage media discussed above and illustrated in FIG. 4, provide storage of computer readable instructions, data structures, program modules and other data for the computer 441. In FIG. 4, for example, hard disk drive 438 is illustrated as storing operating system 458, application programs 457, other program modules 456, and program data 455. Note that these components can either be the same as or different from operating system 425, application programs 426, other program modules 427, and program data 428. Operating system 458, application programs 457, other program modules 456, and program data 455 are given different numbers here to illustrate that, at a minimum, they are different copies. A user may enter commands and information into the computer 441 through input devices such as a keyboard 451 and pointing device 452, commonly referred to as a mouse, trackball or touch pad. Other input devices (not shown) may include a microphone, joystick, game pad, satellite dish, scanner, or the like. These and other input devices are often connected to the processing unit 459 through a user input interface 436 that is coupled to the system bus, but may be connected by other interface and bus structures, such as a parallel port, game port or a universal serial bus (USB). The cameras 226, 228 and capture device 120 may define additional input devices for the computing system 420 that connect via user input interface 436. A monitor 442 or other type of display device is also connected to the system bus 421 via an interface, such as a video interface 432. In addition to the monitor, computers may also include other peripheral output devices such as speakers 444 and printer 443, which may be connected through a output peripheral interface 433. Capture Device 120 may connect to computing system 420 via output peripheral interface 433, network interface 437, or other interface.

The computer 441 may operate in a networked environment using logical connections to one or more remote computers, such as a remote computer 446. The remote computer 446 may be a personal computer, a server, a router, a network PC, a peer device or other common network node, and typically includes many or all of the elements described above relative to the computer 441, although only a memory storage device 447 has been illustrated in FIG. 4. The logical connections depicted include a local area network (LAN) 445 and a wide area network (WAN) 449, but may also include other networks. Such networking environments are commonplace in offices, enterprise-wide computer networks, intranets and the Internet.

When used in a LAN networking environment, the computer 441 is connected to the LAN 445 through a network interface 437. When used in a WAN networking environment, the computer 441 typically includes a modem 450 or other means for establishing communications over the WAN 449, such as the Internet. The modem 450, which may be internal or external, may be connected to the system bus 421 via the user input interface 436, or other appropriate mechanism. In a networked environment, program modules depicted relative to the computer 441, or portions thereof, may be stored in the remote memory storage device. By way of example, and not limitation, FIG. 4 illustrates application programs 448 as residing on memory device 447. It will be appreciated that the network connections shown are exemplary and other means of establishing a communications link between the computers may be used.

As explained above, the capture device 120 provides RGB images (also known as color images) and depth images to the computing system 112. The depth image may be a plurality of observed pixels where each observed pixel has an observed depth value. For example, the depth image may include a two-dimensional (2-D) pixel area of the captured scene where each pixel in the 2-D pixel area may have a depth value such as a length or distance in, for example, centimeters, millimeters, or the like of an object in the captured scene from the capture device.

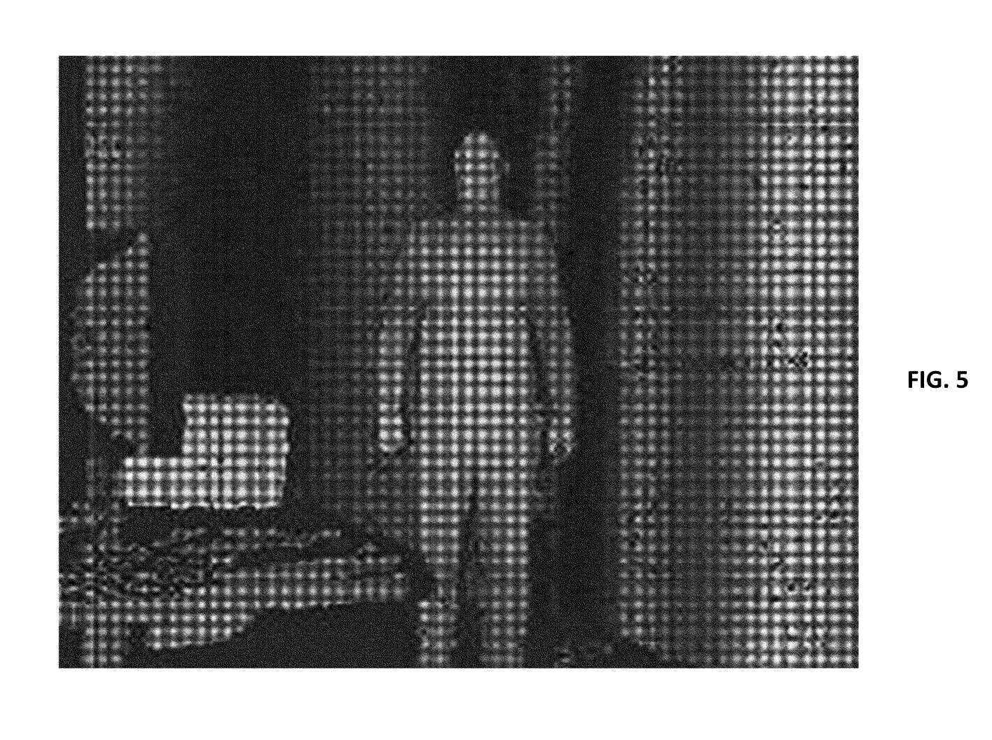

FIG. 5 illustrates an example embodiment of a depth image that may be received at computing system 112 from capture device 120. According to an example embodiment, the depth image may be an image and/or frame of a scene captured by, for example, the 3-D camera 226 and/or the RGB camera 228 of the capture device 120 described above with respect to FIG. 2A. As shown in FIG. 5, the depth image may include a human target corresponding to, for example, a user such as the user 118 described above with respect to FIGS. 1A and 1B and one or more non-human targets such as a wall, a table, a monitor, or the like in the captured scene. The depth image may include a plurality of observed pixels where each observed pixel has an observed depth value associated therewith. For example, the depth image may include a two-dimensional (2-D) pixel area of the captured scene where each pixel at particular x-value and y-value in the 2-D pixel area may have a depth value such as a length or distance in, for example, centimeters, millimeters, or the like of a target or object in the captured scene from the capture device. In other words, a depth image can specify, for each of the pixels in the depth image, a pixel location and a pixel depth. Following a segmentation process, each pixel in the depth image can also have a segmentation value associated with it. The pixel location can be indicated by an x-position value (i.e., a horizontal value) and a y-position value (i.e., a vertical value). The pixel depth can be indicated by a z-position value (also referred to as a depth value), which is indicative of a distance between the capture device (e.g., 120) used to obtain the depth image and the portion of the user represented by the pixel. The segmentation value is used to indicate whether a pixel corresponds to a specific user, or does not correspond to a user.

In one embodiment, the depth image may be colorized or grayscale such that different colors or shades of the pixels of the depth image correspond to and/or visually depict different distances of the targets from the capture device 120. Upon receiving the image, one or more high-variance and/or noisy depth values may be removed and/or smoothed from the depth image; portions of missing and/or removed depth information may be filled in and/or reconstructed; and/or any other suitable processing may be performed on the received depth image.

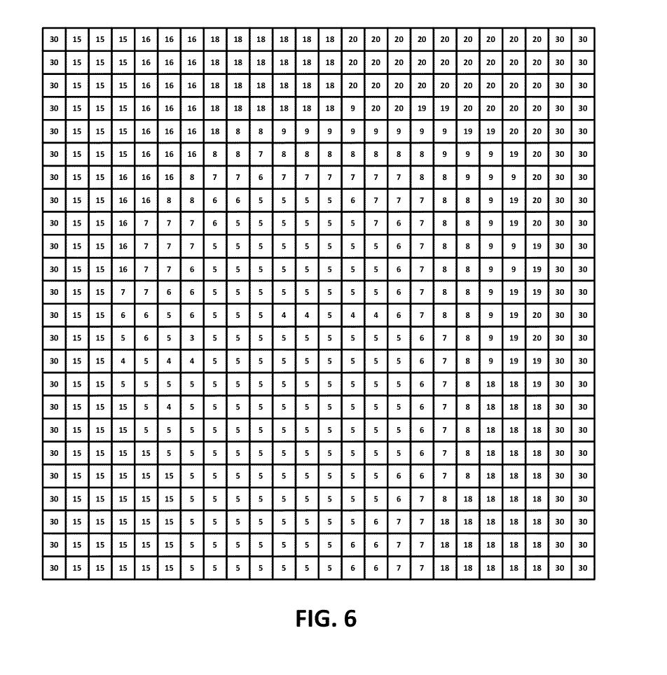

FIG. 6 provides another view/representation of a depth image (not corresponding to the same example as FIG. 5). The view of FIG. 6 shows the depth data for each pixel as an integer that represents the distance of the target to capture device 120 for that pixel. The example depth image of FIG. 6 shows 24×24 pixels; however, it is likely that a depth image of greater resolution would be used.

### Techniques for Spreading Laser Beam and Thereby Increasing Laser Footprint

As mentioned above, the light projected by a depth camera can be a high frequency (HF) modulated laser beam generated using a laser source that outputs an IR laser beam. While an IR laser beam traveling through the air is not visible to the human eye, the point from which the IR laser beam is output from the depth camera may look very bright and draw attention to the laser light. This can be distracting, and thus, is undesirable. Certain embodiments of the present technology, which are described below, are directed to an optical module that spreads out a laser beam, output by a laser source, so that the laser beam output by the optical module does not look bright, and thus, does not draw attention to the laser light. Further, such embodiments also modify the laser beam so that its horizontal and vertical angles of divergence are substantially equal to desired horizontal and vertical angles of divergence, and so that its illumination profile is substantially equal to a desired illumination profile. This is beneficial since a scene should be illuminated by light having predetermined desired horizontal and vertical angles of divergence and a predetermined desired illumination profile in order for the depth camera to obtain high resolution depth images.

FIG. 7 illustrates an optical module 702 for use with a depth camera, according to an embodiment of the present technology. The optical module 702 is shown as including a laser source 712 and an optical structure 722. Referring back to FIG. 2B, the optical module 702 in FIG. 7 can be used as the optical module 256 in FIG. 2B, in which case the laser source 712 in FIG. 7 can be used as the laser source 250 in FIG. 2B, and the optical structure 722 in FIG. 7 can be used as the optical structure 252 in FIG. 2B.

The laser source 712, which can include one or more laser emitting elements, such as, but not limited to, edge emitting laser diodes or vertical-cavity surface-emitting lasers (VCSELs), outputs a laser beam having first horizontal and vertical angles of divergence. For example, the horizontal angle of divergence of the laser beam output by the laser source 702 can be 18 degrees, and the vertical angle of divergence of the laser beam output by the laser source 702 can be 7 degrees. Stated another way, the first horizontal and vertical angles of divergence can be 18 degrees and 7 degrees, respectively. The optical structure 722 receives the laser beam output by the laser source 702 and modifies the horizontal and vertical angles of divergence and the illumination profile of the laser beam. The illumination profile, as the term is used herein, is a map of the intensity of light across a field of view.

In accordance with specific embodiments, the optical structure 722 spreads out the laser beam output by the laser source 712 in at least two stages so that the laser beam output from the optical structure 722 has horizontal and vertical angles of divergence substantially equal to desired horizontal and vertical angles of divergence. Additionally, the optical structure 722 modifies an illumination profile of the laser beam output by the laser source 712 so that the illumination profile of the laser beam output from the optical structure 722 is substantially equal to a desired illumination profile. Desired horizontal and vertical angles of divergence can be optimized for the scene that is to be illuminated by the laser beam, which may depend, for example, on the width and height of the scene, as well as the expected distance between the optical structure and an object (e.g., a person) in the scene to be illuminated. The desired illumination profile can also be optimized for the scene that is to be illuminated by the laser beam, which may similarly depend, for example, on the width and height of the scene, as well as the expected distance between the optical structure and an object (e.g., a person) in the scene to be illuminated.

In accordance with an embodiment, the optical structure 722 includes a first lens surface 724, which can more generally be referred to as a first optical element, that receives the laser beam having the first horizontal and vertical angles of divergence and increases the first horizontal and vertical angles of divergence of the laser beam to second horizontal and vertical angles of divergence. In FIG. 7, the first lens surface 724 is shown as being a concave lens surface. The second horizontal and vertical angles of divergence can be, for example, 38 degrees and 24 degrees, respectively.

The optical structure 722 also includes a second lens surface 726, which can more generally be referred to as a second optical element, that receives the laser beam having the second horizontal and vertical angles of divergence and decreases the second horizontal and vertical angles of divergence of the laser beam to third horizontal and vertical angles of divergence. In FIG. 7, the second lens surface 726 is shown as being a convex lens surface. The third horizontal and vertical angles of divergence can be, for example, 24 degrees and 15 degrees, respectively. In accordance with an embodiment, a distance between the first lens surface 724 (and more generally, the first optical element) and the second lens surface 726 (and more generally, the second optical element) is large enough to achieve an amount of beam spreading that is desired to occur between these two lens surfaces/optical elements, but is preferably no larger than necessary so as to allow the overall optical structure 722 to be a small as possible.

The optical structure 722 also includes a third optical element 730 that receives the laser beam having the third horizontal and vertical angles of divergence, increases the third horizontal and vertical angles of divergence of the laser beam to fourth horizontal and vertical angles of divergence that are substantially equal to the desired horizontal and vertical angles of divergence, and modifies an illumination profile of the laser beam so that the illumination profile of the laser beam exiting the third optical element 730 is substantially equal to the desired illumination profile.

In FIG. 7, the first and second optical elements 724, 726 are lens surfaces of a meniscus lens 728. More specifically, the concave lens surface 724 and the convex lens surface 726 are opposing surfaces of the meniscus lens 728. In an alternative embodiment, the first optical element 724 can be a surface of a thin concave lens, and the second optical element 726 can be a surface of a separate thin convex lens. In other words, the first and second optical elements 724, 726 can be implemented using two separate lenses, as opposed to the single meniscus lens 728. In accordance with an embodiment, the optical power of the meniscus lens 728 (or more generally, the collectively optical power of the concave lens surface 724 and the convex lens surface 726) is nearly zero, meaning the meniscus lens has a diopter within a range 0.0001 mm⁻¹ to 0.05 mm⁻¹. An advantage of using a nearly zero power meniscus lens is that positional tolerances are minor and imperfections in the lens will have a very minor effect on the resulting illumination profile.

In other embodiments, one or more of the first and second optical elements 724 and 726 can be implemented by a gradient-index lens. For a specific example, the first and second optical elements 724 and 726 can be implemented by opposing surfaces of a double sided gradient-index lens. For another example, the first optical element 724 can be implemented by a first gradient-index lens, and the second optical element 726 can be implemented by a second gradient-index lens.

In still other embodiments, one or more of the first and second optical elements 724 and 726 can be implemented by a diffractive optical element. For a specific example, the first and second optical elements 724 and 276 can be implemented by opposing surfaces of a double sided diffractive optical element. For another example, the first optical element 724 can be implemented by a first diffractive optical element, and the second optical element 726 can be implemented by a second diffractive optical element.

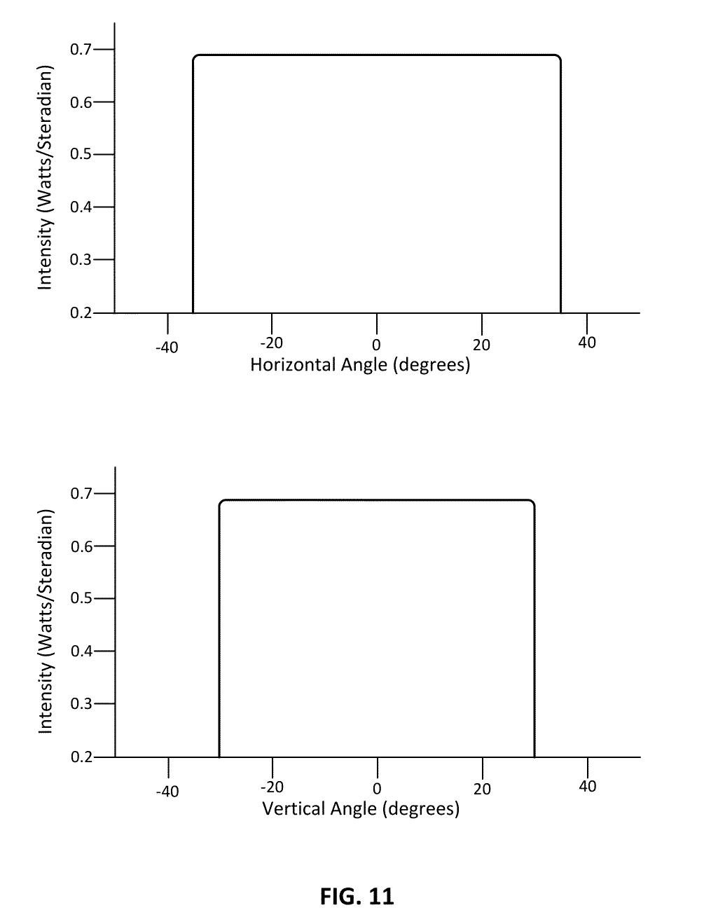

In accordance with certain embodiments, the third optical element 730 is a micro-lens array. In an alternative embodiment, the third optical element 730 is a diffractive optical element. In still another embodiment, the third optical element 730 is an optical diffuser. Regardless of the embodiment, the third optical element 730 should be configured to output an illumination profile substantially similar to a predetermined desired illumination profile. Additionally, the third optical element should be configured such that the laser beam exiting the third optical element should have horizontal and vertical angles of divergence that are substantially equal to the desired horizontal and vertical angles of divergence. Exemplary desired horizontal and vertical angles of divergence are 70 degrees and 60 degrees, respectively. FIG. 11 includes exemplary graphs that illustrate an exemplary desired illumination profile. This is just one example, which is not meant to be limiting, but rather, has been included for illustrative purposes.

Various combinations of the aforementioned embodiments are also within the scope of an embodiment of the present technology. For example, the first optical element 724 can be implemented using any one of a concave lens, a gradient-index lens or a diffractive optical element; the second optical element 726 can be implemented using any one of a convex lens, a gradient-index lens or a diffractive optical element; and the third optical element 730 can be implemented by any one of a micro-lens array, a diffractive optical element or an optical diffuser.

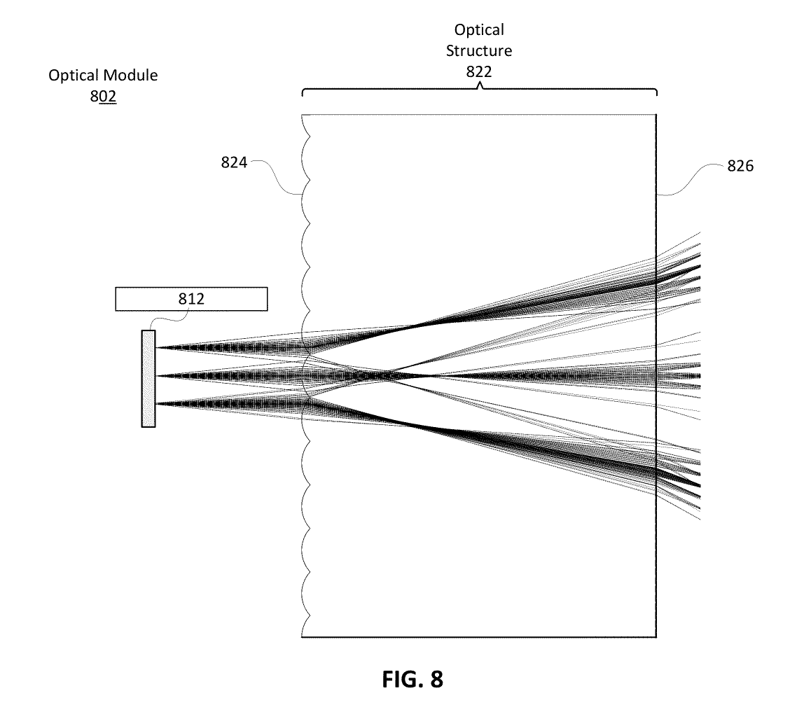

FIG. 8 illustrates an optical module 802 for use with a depth camera, according to another embodiment of the present technology. The optical module 802 is shown as including a laser source 812 and an optical structure 822. Referring back to FIG. 2B, the optical module 802 in FIG. 7 can be used as the optical module 256 in FIG. 2B, in which case the laser source 812 in FIG. 8 can be used as the laser source 250 in FIG. 2B, and the optical structure 822 in FIG. 8 can be used as the optical structure 252 in FIG. 2B. Exemplary details of the laser source 812 are the same as those discussed above with reference to the laser source 712 in FIG. 7. As was the case with the optical structure 722, the optical structure 822 spreads out the laser beam output by the laser source 812 in at least two stages so that the laser beam output from the optical structure 822 has horizontal and vertical angles of divergence substantially equal to desired horizontal and vertical angles of divergence. Additionally, the optical structure 822 modifies an illumination profile of the laser beam output by the laser source 812 so that the illumination profile of the laser beam output from the optical structure 822 is substantially equal to a desired illumination profile.

In accordance with an embodiment, the optical structure 822 includes a first optical element 824 and a second optical element 826. The optical structure 822 receives the laser beam output by the laser source 802 and modifies the horizontal and vertical angles of divergence and the illumination profile of the laser beam. The first optical element 824 receives the laser beam having the first horizontal and vertical angles of divergence and increases the first horizontal and vertical angles of divergence of the laser beam to second horizontal and vertical angles of divergence. For example, the horizontal angle of divergence of the laser beam output by the laser source 802 can be 18 degrees, and the vertical angle of divergence of the laser beam output by the laser source 802 can be 7 degrees. Stated another way, the first horizontal and vertical angles of divergence can be 18 degrees and 7 degrees, respectively. The second horizontal and vertical angles of divergence can be, for example, 40 degrees and 44 degrees, respectively.

The second optical element 826 that receives the laser beam having the second horizontal and vertical angles of divergence, increases the second horizontal and vertical angles of divergence of the laser beam to third horizontal and vertical angles of divergence that are substantially equal to the desired horizontal and vertical angles of divergence, and modifies an illumination profile of the laser beam so that the illumination profile of the laser beam exiting the second optical element 826 is substantially equal to the desired illumination profile. The third horizontal and vertical angles of divergence can be, for example, 70 degrees and 60 degrees, respectively, which are substantially equal to the exemplary desired horizontal and vertical angles of divergence.

In accordance with an embodiment, the first optical element 824 is a first micro lens array and the second optical element 826 is a second micro lens array. In a specific embodiment, the optical structure 822 is implemented using a double sided micro-lens array, in which case the first optical element 824 is implemented using a first side of the double sided micro-lens array, and the second optical element 826 is implemented using a second side of the double sided micro-lens array. Such an embodiment is shown in FIG. 8.

In an alternative embodiment, the first optical element 824 is implemented using a diffractive optical element. It is also possible that the second optical element 826 is implemented using a diffractive optical element. Accordingly, in a specific embodiment, the optical structure 822 is implemented using a double sided diffractive optical element, in which case the first optical element 824 is implemented using a first side of the double sided diffractive optical element, and the second optical element 826 is implemented using a second side of the double sided diffractive optical element.

In still another embodiment, the second optical element 826 is implemented using an optical diffuser. Various combinations of the aforementioned embodiments are also within the scope of an embodiment of the present technology. For example, the first optical element 824 can be implemented using any one of a micro-lens array or a diffractive optical element; and the second optical element 826 can be implemented using any one of a micro-lens array, a diffractive optical element or an optical diffuser.

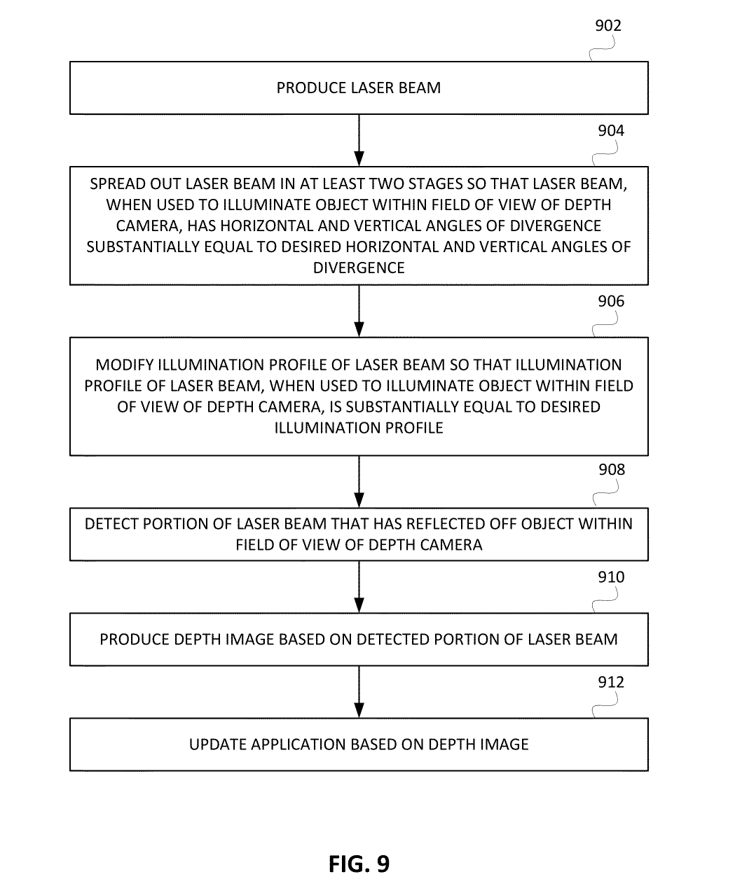

FIG. 9 is a high level flow diagram that is used to summarize methods according to various embodiments of the present technology. Such methods are for use with a depth camera, especially a depth camera that produces depth images based on time-of-flight (TOF) measurements.

Referring to FIG. 9, at step 902, a laser beam is produced. As indicated at step 904, the laser beam is spread out in at least two stages so that the laser beam, when used to illuminate an object within a field of view of the depth camera, has horizontal and vertical angles of divergence substantially equal to desired horizontal and vertical angles of divergence. As indicated at step 906, an illumination profile of the laser beam is modified so that the illumination profile of the laser beam, when used to illuminate an object within a field of view of the depth camera, is substantially equal to a desired illumination profile. At least a portion of step 906 is likely performed at the same time as at least a portion of step 904. In other words, the flow diagram is not intended to imply that step 904 is completed before step 906 begins. In one embodiment, steps 904 and 906 are performed simultaneously.

As explained above, step 902 can be performed by a laser source, exemplary details of which were discussed above. As also explained above, step 904 and 906 can be performed by an optical structure, details of which were discussed above with reference to FIGS. 7 and 8. For example, the optical structure can include a meniscus lens followed by a micro lens array, as discussed above with reference to FIG. 7. The meniscus lens performs some initial spreading of the beam, and then the micro lens array performs further spreading of the beam and is also used to achieve the illumination profile that is substantially equal to the desired illumination profile. The meniscus lens includes a concave lens surface followed by a convex lens surface, each of which adjust the horizontal and vertical angles of divergence of the laser beam. Accordingly, the meniscus lens can be said to perform a first stage of beam spreading, and the optically downstream micro-lens array can be said to perform a second stage of the beam spreading. In accordance with an embodiment, a distance between the concave lens surface (and more generally, the first lens surface or first optical element 724) and the convex lens surface (and more generally, the second lens surface or second optical element 726) is large enough to achieve a desired first stage of beam spreading, but is preferably no larger than necessary so as to allow the overall optical structure to be a small as possible. In alternative embodiments, the first stage beam spreading can be performed by a micro-lens array, a diffractive optical element or a gradient-index lens, instead of a meniscus lens. In other embodiments, the second stage beam spreading is performed by a diffractive optical element or an optical diffuser, instead of a micro-lens array. Additional details of steps 902, 904 and 906 can be appreciated by the above discussion of FIGS. 7 and 8.

Still referring to FIG. 9, at step 908 a portion of the laser beam that has reflected of an object within a field of view of the depth camera is detected. As can be appreciated by the above discussion of FIG. 2B, an image pixel detector array (e.g., 268 in FIG. 2B) can be used to perform step 908. At step 910, a depth image is produced based on the portion of the laser beam detected at step 908. At step 912, an application is updated based on the depth image. For example, the depth image can be used to change a position or other aspect of a game character, or to control an aspect of a non-gaming application, but is not limited thereto. Additional details of methods of embodiments of the present technology can be appreciated from the above discussion of FIGS. 1A-8.

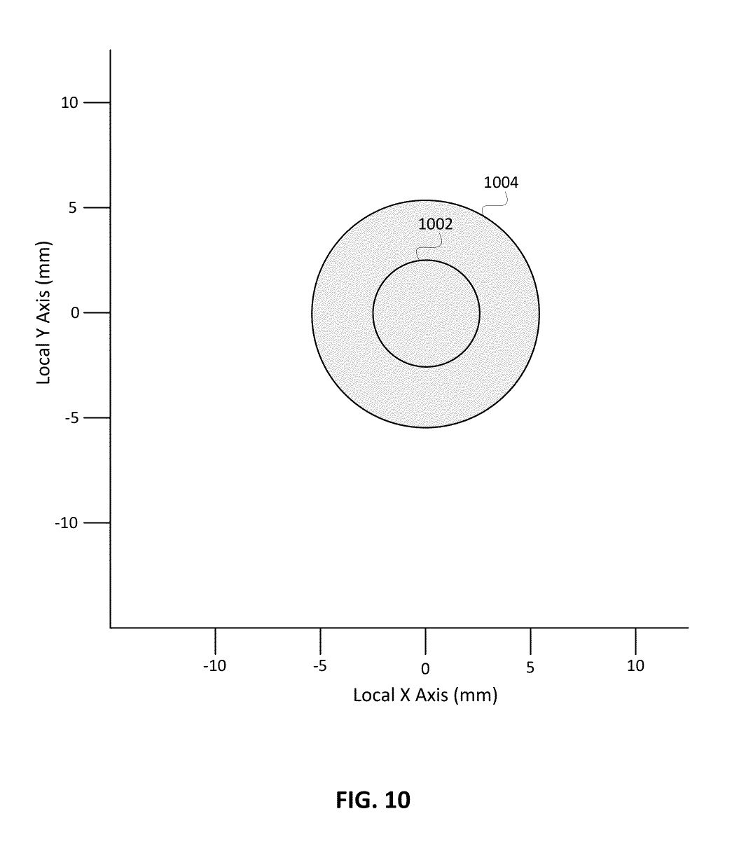

Embodiments of the present technology, which were described above, can be used to increase the footprint of a laser beam over a relatively short path length between the laser source that produces a laser beam and the optical structure that spreads the laser beam and achieves an illumination profile substantially equal to a desired illumination profile. For example, the path length from the right side of the optical source block 712 in FIG. 7 to the right side of the micro lens array 730 can be less than 20 mm, and more specifically, can be about 15 mm. Nevertheless, the optical structure 722 in FIG. 7 can be used to significantly increase the footprint of the laser beam. For example, referring to FIG. 10, the footprint 1002 is illustrative of the footprint of the laser beam leaving the laser source 702, and the footprint 1004 is illustrative of the footprint of the laser beam output from the micro-lens array 730. The optical structure 822 in FIG. 8 can be used to achieve a similar increase in the footprint of the laser beam over a relatively short path length.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the technology be defined by the claims appended hereto.

What is claimed is:

1. An optical module for use with a depth camera, the optical module comprising:
a laser source that outputs a laser beam; and
an optical structure that
receives the laser beam output by the laser source,
spreads out the laser beam output by the laser source in at least two stages so that the laser beam output from the optical structure has horizontal and vertical angles of divergence substantially equal to desired horizontal and vertical angles of divergence, and
modifies an illumination profile of the laser beam so that the illumination profile of the laser beam output from the optical structure is substantially equal to a desired illumination profile.

2. The optical module of claim 1, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence;
a second optical element that receives the laser beam having the second horizontal and vertical angles of divergence and decreases the second horizontal and vertical angles of divergence of the laser beam to third horizontal and vertical angles of divergence; and
a third optical element that receives the laser beam having the third horizontal and vertical angles of divergence, increases the third horizontal and vertical angles of divergence of the laser beam to fourth horizontal and vertical angles of divergence that are substantially equal to the desired horizontal and vertical angles of divergence, and modifies an illumination profile of the laser beam so that the illumination profile of the laser beam exiting the third optical element is substantially equal to the desired illumination profile.

3. The optical module of claim 2, wherein:
the first optical element comprises a concave lens surface;
the second optical element comprises a convex lens surface; and
the third optical element comprises one of a micro-lens array, a diffractive optical element or an optical diffuser.

4. The optical module of claim 3, wherein:
the concave lens surface and the convex lens surface are opposing surfaces of a meniscus lens.

5. The optical module of claim 4, wherein:
the meniscus lens has a diopter within a range 0.0001 mm⁻¹ to 0.05 mm⁻¹.

6. The optical module of claim 2, wherein:
the first optical element and the second optical element are opposing surfaces of a double-sided gradient-index lens; and
the third optical element comprises one of a micro-lens array, a diffractive optical element or an optical diffuser.

7. The optical module of claim 1, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence; and
a second optical element that receives the laser beam having the second horizontal and vertical angles of divergence, increases the second horizontal and vertical angles of divergence of the laser beam to third horizontal and vertical angles of divergence that are substantially equal to the desired horizontal and vertical angles of divergence, and modifies an illumination profile of the laser beam so that the illumination profile of the laser beam exiting the second optical element is substantially equal to the desired illumination profile.

8. The optical module of claim 7, wherein:
the first optical element comprises one of a micro-lens array or a diffractive optical element; and
the second optical element comprises one of a micro-lens array, a diffractive optical element or an optical diffuser.

9. The optical module of claim 1, wherein the laser source comprises one or more laser diodes each including one or more edge emitting lasers.

10. The optical module of claim 1, wherein the laser source comprises a two dimensional array of vertical cavity surface emitting lasers.

11. For use with a depth camera, a method comprising:
producing a laser beam;
spreading out the laser beam in at least two stages so that the laser beam, when used to illuminate an object within a field of view of the depth camera, has horizontal and vertical angles of divergence substantially equal to desired horizontal and vertical angles of divergence; and
modifying an illumination profile of the laser beam so that the illumination profile of the laser beam, when used to illuminate an object within a field of view of the depth camera, is substantially equal to a desired illumination profile.

12. The method of claim 11, wherein:
the producing a laser beam comprises using a laser source to produce a laser beam;
spreading out the laser beam in out least two stages comprises using an optical structure to spread out the laser beam produced by the laser source in at least two stages so that the laser beam output from the optical structure has horizontal and vertical angles of divergence substantially equal to desired horizontal and vertical angles of divergence; and
the modifying an illumination profile comprises using the optical structure to modify an illumination profile of the laser beam produced by the laser source so that the illumination profile of the laser beam output from the optical structure is substantially equal to a desired illumination profile.

13. The method of claim 12, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence;
a second optical element that receives the laser beam having the second horizontal and vertical angles of divergence and decreases the second horizontal and vertical angles of divergence of the laser beam to third horizontal and vertical angles of divergence; and
a third optical element that receives the laser beam having the third horizontal and vertical angles of divergence, increases the third horizontal and vertical angles of divergence of the laser beam to fourth horizontal and vertical angles of divergence that are substantially equal to the desired horizontal and vertical angles of divergence, and modifies an illumination profile of the laser beam so that the illumination profile of the laser beam exiting the third optical element is substantially equal to the desired illumination profile.

14. The method of claim 13, wherein:
the first optical element comprises a concave lens surface of a meniscus lens;
the second optical element comprises a convex lens surface of the meniscus lens; and
the third optical element comprises one of a micro-lens array, a diffractive optical element or an optical diffuser.

15. The method of claim 12, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence; and
a second optical element that receives the laser beam having the second horizontal and vertical angles of divergence, increases the second horizontal and vertical angles of divergence of the laser beam to third horizontal and vertical angles of divergence that are substantially equal to the desired horizontal and vertical angles of divergence, and modifies an illumination profile of the laser beam so that the illumination profile of the laser beam exiting the second optical element is substantially equal to the desired illumination profile.

16. The method of claim 11, further comprising:
detecting a portion of the laser beam that has reflected of an object within a field of view of the depth camera; and
producing a depth image based on the detected portion of the laser beam; and
updating an application based on the depth image.

17. A depth camera system, comprising:
a laser source that outputs a laser beam;
an optical structure that
receives the laser beam output by the laser source,
spreads out the laser beam output by the laser source in at least two stages so that the laser beam output from the optical structure has horizontal and vertical angles of divergence substantially equal to desired horizontal and vertical angles of divergence, and
modifies an illumination profile of the laser beam so that the illumination profile of the laser beam output from the optical structure is substantially equal to a desired illumination profile; and
an image pixel detector array that detects a portion of the laser beam, output by the optical structure, that has reflected of an object within a field of view of the depth camera and is incident on the image pixel detector array.

18. The depth camera system of claim 17, further comprising:
one or more processors that produce depth images in dependence on outputs of the image pixel detector array.
wherein the one or more processors update an application based on the depth images.

19. The depth camera system of claim 17, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence;
a second optical element that receives the laser beam having the second horizontal and vertical angles of divergence and decreases the second horizontal and vertical angles of divergence of the laser beam to third horizontal and vertical angles of divergence; and
a third optical element that receives the laser beam having the third horizontal and vertical angles of divergence, increases the third horizontal and vertical angles of divergence of the laser beam to fourth horizontal and vertical angles of divergence that are substantially equal to the desired horizontal and vertical angles of divergence, and modifies an illumination profile of the laser beam so that the illumination profile of the laser beam exiting the third optical element is substantially equal to the desired illumination profile.

20. The depth camera system of claim 17, wherein:
the laser beam output by the laser source has first horizontal and vertical angles of divergence; and
the optical structure comprises
a first optical element that receives the laser beam having the first horizontal and vertical angles of divergence and increases the first horizontal and vertical angles of divergence of the laser beam to second horizontal and vertical angles of divergence; and
a second optical element that receives the laser beam having the second horizontal and vertical angles of divergence, increases the second horizontal and vertical angles of divergence of the laser beam to third horizontal and vertical angles of divergence that are substantially equal to the desired horizontal and vertical angles of divergence, and modifies an illumination profile of the laser beam so that the illumination profile of the laser beam exiting the second optical element is substantially equal to the desired illumination profile.
